(19) United States
(12) Patent Application Publication
(10) Pub. No.: US 2008/0105081 A1
(43) Pub. Date: May 8, 2008

(54) Linear Displacement Devices

(76) Inventor: Mark Richard Whittington, Birmingham (GB)

Correspondence Address: DAVIS BUJOLD & Daniels, P.L.L.C., 112 PLEASANT STREET, CONCORD, NH, 03301, US

(21) Appl. No.: 11/792,654

(22) PCT Filed: Nov. 30, 2005
(86) PCT No.: PCT/GB05/04560

§ 371 Date: Jun. 8, 2007

(30) Foreign Application Priority Data
Dec. 9, 2004 (GB) 0426970.0

(51) Int. Cl. F03G 3/00

(52) U.S. Cl. 74/84 R

(57) ABSTRACT

A linear displacement device has a body; a plurality of masses mechanically coupled to the body for reciprocating movement in a common direction with respect to the body; and a mechanism for driving the masses so that they oscillate periodically with different frequencies of oscillation such that; the impulse applied to the body by the oscillating masses, in one direction is in excess of the minimum impulse required to move the body in the one direction, by a greater amount. than the reaction impulse applied to the body in the opposite direction is in excess of the impulse required to move the body in the opposite direction, so that the body will move in the one direction.

This is a national stage completion of PCT/GB2005/004560 filed Nov. 30, 2005 which claims priority from British Application Serial No. 0426970.0 filed Dec. 9, 2004.

### FIELD OF THE INVENTION

The present invention relates to linear displacement devices which may be used as propulsion units or actuators, for moving objects or components. The linear displacement device is preferably totally encapsulated and requires only minimal mechanical coupling to the object or component.

### SUMMARY OF THE INVENTION

According to one aspect of the present invention a linear displacement device comprises; a body, a plurality of masses mechanically coupled to the body for reciprocating movement in a common direction with respect to the body and means for driving the masses so that they oscillate periodically with different frequencies of oscillation such that;

over a time period T₀ to T₁, the resultant impulse produced by the periodic oscillation of the masses

$${\int }_{T 0}^{T 1} Fx ( t ) \cdot d t = 0$$

where:—

Fx(t) is the resultant force produced by oscillation of the masses at a particular instant in time=[Fx1(t)+Fx2(t)+ . . . +Fxn(t)]; and Fx1(t), Fx2(t) . . . Fxn(t) is the force applied to the body at a particular instant in time, by a first oscillating mass, a second oscillating mass . . . and by an n^{th} oscillating mass respectively;

and:

over that time period T₀ to T₁,

$${\int }_{T 0}^{T 1} Sx ( t ) \cdot d t \neq 0$$

where

### Sx(t)=the resultant force on the body, produced by the periodic oscillation of the masses, in excess of a force which must be exceeded in order to move the body at a particular instant in time;

### =Fx(t)−f+x(t) when Fx(t) acts on the body in one direction and is in excess of the force f+x(t) which must be exceeded in order to move the body in said one direction;

### =Fx(t)−f−x(t) when Fx(t) acts on the body in an opposite direction and is in excess of the force f−x(t) which must be exceeded in order to move the body in said opposite direction;

=0 when |Fx(t)|is less than or equal to the modulus of the force |f+x(t)|or |f−x(t)|which must be exceeded in order to move the body in either said one direction or said opposite direction, respectively.

Linear displacement devices in accordance with the present invention may be coupled to an object or component for movement of the object or component in a given direction, where movement of the object or component is opposed by, for example, friction, the viscous drag of a fluid, a mechanical torque or an electric or magnetic field, so that a minimum impulse is required to move the object or component.

Provided that the impulse applied to the object or component in said one direction is in excess of the minimum impulse required to move the object or component in that direction and the difference in the impulse applied to the object or component over the minimum impulse, is greater than the difference in the reaction impulse applied to the object and the minimum impulse required to move the object or component in the opposite direction, the object or component will move in said one direction. Preferable the reaction impulse will remain lower than the minimum impulse required to move the object or component in the reverse direction. Moreover the higher the frequency of oscillation of the masses of the linear displacement device, the smoother the motion of the object or component.

Linear displacement devices according to the present invention may have two or more oscillating masses. When two masses are used, the frequency of oscillation of the second mass is preferably twice that of the first mass. Moreover, the maximum force produced by the second mass is preferably equal to that produced by the first mass. This may be achieved by making the first mass 4 times heavier than the second mass, or by reducing the amplitude of oscillation of the second mass to one quarter of that of the first mass.

For three or more masses, the frequencies of oscillation are preferably a multiple of the lowest frequency. The masses and/or amplitudes of oscillation of the masses may again be adjusted so that the maximum force applied by the masses are equal. However, according to a preferred embodiment, the masses are arranged to produce linearly decending forces, for example if the frequencies of oscillation of the masses are in the ratio 1:2:3: . . . :n, then the maximum force amplitude produced by each if the masses should be in the ratio n:n-1:n-2: . . . :1.

The masses preferably remain in phase, so that the motion applied to the body will be in one direction. Means may however be provided for introducing a phase shift, in order to reverse the direction of movement of the body. For a two mass system, this phase shift will be 90°. Alternatively, the masses may be arranged to be out of phase, such that over a period the direction of motion of the body will reverse.

The linear displacement device according to the present invention may be coupled to a component, mounted for rotation about an axis, the device being spaced from the axis, so that the linear displacement device applies a non-radial impulse to the component, in order to form a rotary displacement device.

### BRIEF DESCRIPTION OF THE DRAWINGS

The invention is now described, with reference to the accompanying drawings, in which:—

FIG. 1 is a diagrammatic illustration of a linear displacement device, in accordance with the present invention;

FIGS. 2a, 2b and 2c are force diagrams for a first mass, a second mass and a combination of the masses respectively, for the device illustrated in FIG. 1;

FIG. 3 is a force diagram for the combination of masses of the device illustrated in FIG. 1, with a phase shift of 90°;

FIG. 4 is a force diagram for the combination of masses of a ten mass linear displacement device in accordance with the present invention;

FIG. 5 illustrates diagramatically a mechanical embodiment of the linear displacement device illustrated in FIG. 1;

FIG. 6 illustrates diagramatically a second mechanical embodiment of the linear displacement device illustrated in FIG. 1;

FIG. 7 illustrates diagramatically a third mechanical embodiment of the linear displacement device illustrated in FIG. 1;

FIG. 8 illustrates diagramatically a fourth mechanical embodiment of the linear displacement device illustrated in FIG. 1;

FIG. 9 illustrates diagramatically an application of the linear displacement device illustrated in FIG. 1;

FIG. 10 illustrates diagramatically a further application of the linear displacement device illustrated in FIG. 1; and

FIG. 11 illustrates diagramatically a further application of the linear displacement device illustrated in FIG. 1.

### DETAILED DESCRIPTION OF THE INVENTION

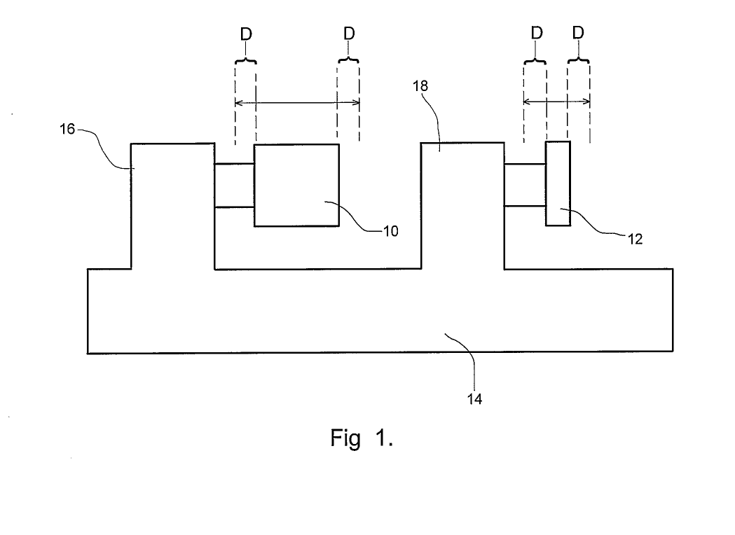

As illustrated in FIG. 1 a linear displacement device comprises first and second masses 10, 12 mounted, for reciprocating movement on a body 14. Means 16, 18 is provided for reciprocating the masses 10, 12, so that mass 10 oscillates at an angular frequency (ω) and mass 12 oscillates at a angular frequency (2ω) equal to twice that of mass 10, the masses 10 and 12, oscillating in phase.

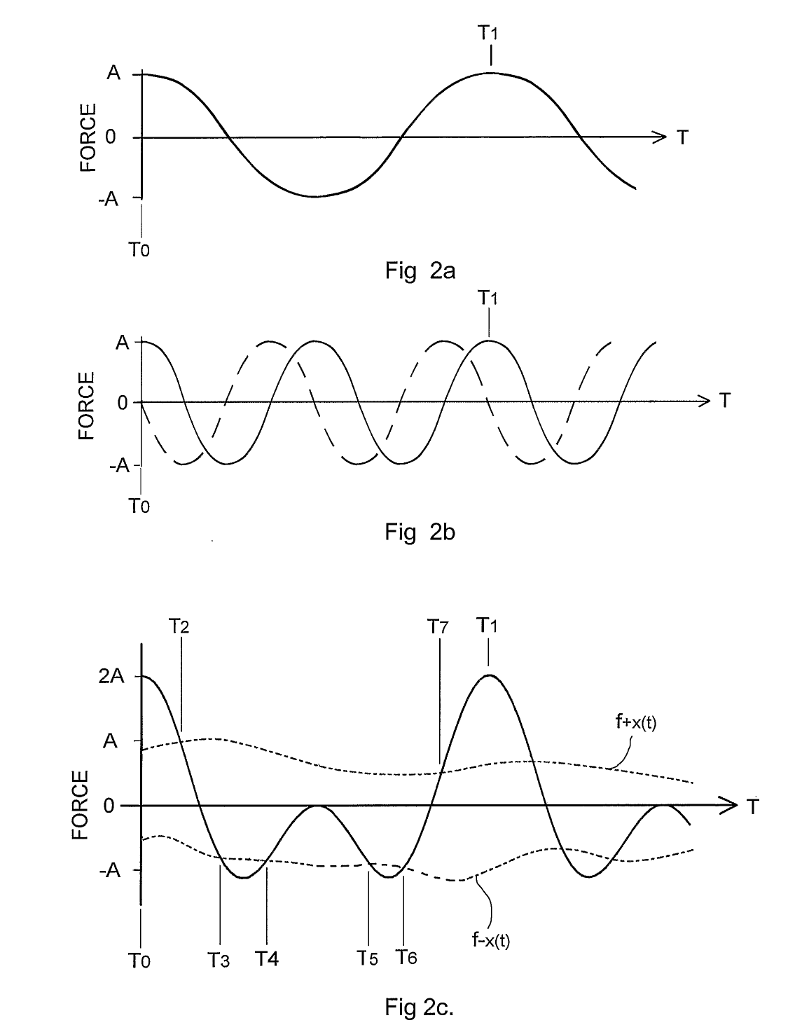

Mass 10 has a mass of four times that of mass 12 and both masses oscillate with equal displacement, so that each of the masses 10 and 12 have the same maximum force amplitude, as illustrated in FIGS. 2a and 2b.

When both masses 10, 12 oscillate in phase, as illustrated in full line in FIG. 2b, the forces generated by the two masses 10, 12, will result in a force which is applied to the body 14, as indicated in FIG. 2c.

The maximum force amplitude applied by each of the masses 10, 12

A=M·D·ω²

where;
M=mass;
D=displacement; and
ω=angular frequency of oscillation.

Therefore;
for mass 10:
   The maximum force amplitude A₁=M₁·D₁·ω₁²
For mass 12:
   The maximum force amplitude A₂=M₂·D₂·ω₂²

Thus, when M₁=4M₂; D₁=D₂; and 2ω₁=ω₂

A₁=M₁·D₁·ω₁²=4M₂·D₂·ω₂²/4=A₂

The force generated by mass 10=A₁·cos(ω₁·t+φ₁)

The force generated by mass 12=A₂·cos(ω₂·t+φ₂)

Where φ₁ and φ₂ are the phases of the forces produced by the first and second masses 10, 12.

And the resultant force on body 14 at any instance

$$\begin{matrix}Fx ( t ) = {A}_{1} \cdot cos ( {ω}_{1} \cdot t + {φ}_{1} ) + {A}_{2} \cdot cos ( {ω}_{2} t + {φ}_{2} ) \\ = {A}_{1} \cdot ( cos ( {ω}_{1} \cdot t ) + cos ( 2 \cdot {ω}_{1} \cdot t ) )\end{matrix}$$

$$when {A}_{1} = {A}_{2} ; and$$

$${φ}_{1} = {φ}_{2} = 0.$$

As illustrated in FIG. 2c, the resultant force diagram shows that a single impulse, with a maximum force amplitude of 2A₁ will act on the body 14 in one direction (+), while a double reaction impulse, with maximum amplitude of A₁, will act on the body 14 in the opposite direction (−).

In accordance with the third law of motion;

$${\int }_{T 0}^{T 1} Fx ( t ) \cdot d t = 0$$

that is, the impulse applied to the body 14 in one direction is equal to the sum of the reaction impulses applied to the body 14 in the opposite direction.

However, movement of the body 14 in each direction is opposed by, for example static friction, as a result of which, the body will not move in either direction, unless the force Fx(t) applied to the body 14 is in excess of a minimum force f+x(t) for movement in one direction (+), or f−x(t) for movement in the opposite direction.

In the example given above, as shown in FIG. 2c:

$$\vert \begin{matrix}{\int }_{T 0}^{T 2} [ Fx ( t ) \cdot d t - f + x ( t ) \cdot d t ] + \\ {\int }_{T 7}^{T 1} [ Fx ( t ) \cdot d t - f + x ( t ) \cdot d t ]\end{matrix} \vert > \vert \begin{matrix}{\int }_{T 3}^{T 4} [ Fx ( t ) \cdot d t - f - x ( t ) \cdot d t ] + \\ {\int }_{T 5}^{T 6} [ Fx ( t ) \cdot d t - f - x ( t ) \cdot d t ]\end{matrix} \vert$$

therefore the body will move in said one direction (+).

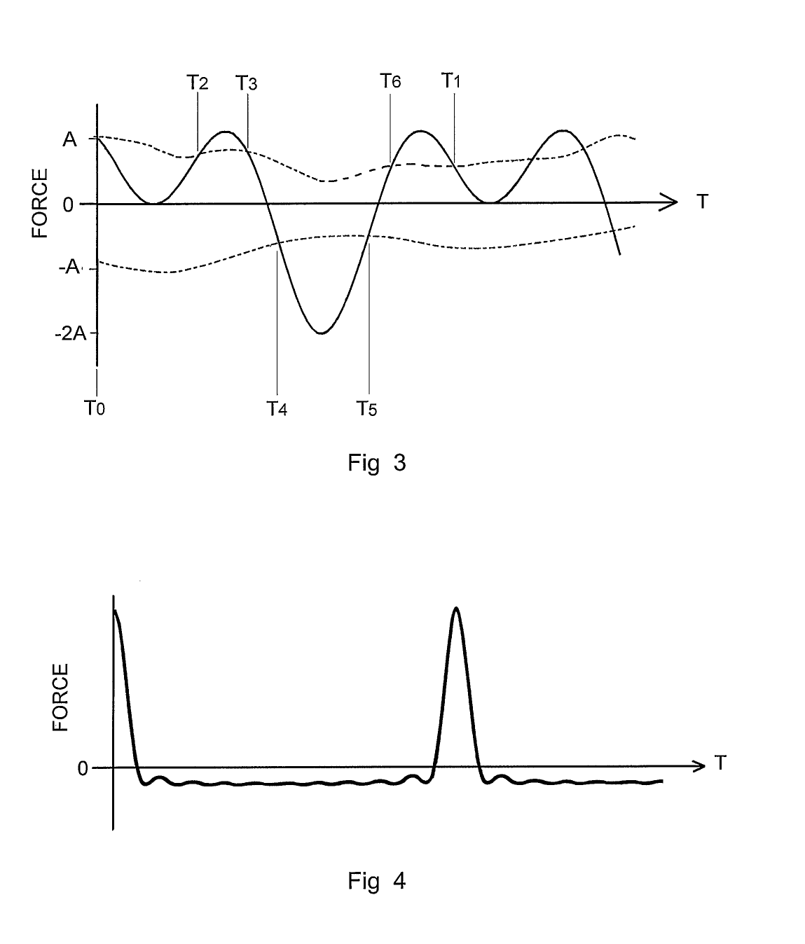

In the periods T₂−T₃; T₄−T₅; and T₆−T₇ the force applied to the body by oscillation of the masses is insufficient to move the body.

Whereas, as shown in FIG. 3:—

$$\vert \begin{matrix}{\int }_{T 2}^{T 3} [ Fx ( t ) \cdot d t - f + x ( t ) \cdot d t ] + \\ {\int }_{T 6}^{T 7} [ Fx ( t ) \cdot d t - f + x ( t ) \cdot d t ]\end{matrix} \vert < \vert {\int }_{T 4}^{T 5} [ Fx ( t ) \cdot d t - f - x ( t ) \cdot d t ] \vert$$

and the body will move in the opposite direction (−)

That is, the body will move, provided that:

$${\int }_{T 0}^{T 1} Sx ( t ) \cdot d t \neq 0$$

where

### Sx(t)=the resultant force on the body, produced by the periodic oscillation of the masses, in excess of a force which must be exceeded in order to move the body at a particular instant in time;

### =Fx(t)−f+x(t) when Fx(t) acts on the body in one direction and is in excess of the force f+x(t) which must be exceeded in order to move the body in said one direction;

### =Fx(t)−f−x(t) when Fx(t) acts on the body in an opposite direction and is in excess of the force f−x(t) which must be exceeded in order to move the body in said opposite direction;

=0 when |Fx(t)|is less than or equal to the modulus of the force |f+x(t)|or |f−x(t)|which must be exceeded in order to move the body in either said one direction or said opposite direction, respectively.

As illustrated in FIG. 3, if a phase difference of 90° is introduced between the two masses 10, 12 (as shown in broken line in FIG. 2b, then a double impulse with a maximum force of amplitude A₁ will act on the body 14 in said first direction (+) and a single impulse with a maximum force amplitude 2A₁ will act on the body 14 in the opposite direction (−), so that the body will move in the opposite direction. The direction of movement of the body 14 may thus be reversed by introducing a phase difference of 90° between the oscillation of the two masses.

The linear displacement device may incorporate more than two oscillating masses, the angular frequency of oscillation, mass, displacement and phase of the masses being selected to tune the resultant force diagram, to provide the required impulse and resultant impulse on the body 14.

For example, FIG. 4 shows a force diagram, for a ten mass linear displacement device, in which each mass has:
An angular frequency of oscillation=y·ω
   a mass=M(n+1−y)/y²
   displacement=D
   phase=0
      where;
n=number of masses=10
y=1 to n
   the maximum force amplitude for each mass Ay=(n+1−y)A
   and;

Fx(t)=10·A·cos(ω·t)+9·A·cos(2·ω·t)+ . . . +1·A·cos(10·ω·t)

As shown in FIG. 4, this arrangement results in a single impulse having a large maximum force amplitude but of short duration, acting on the body 14 in one direction, while the resultant impulse is of long duration but small maximum force amplitude on the opposite direction. This form of linear displacement device would be suitable for applications where the minimum force required to move the body in the reverse direction is relatively low.

For the general case of a linear displacement device having n oscillating masses,

Fx(t)=A₁·cos(ω₁·t+φ₁)+A₂·cos(ω₂·t+φ₂)+ . . . +Aₙ·cos(ωₙ·t+φₙ)

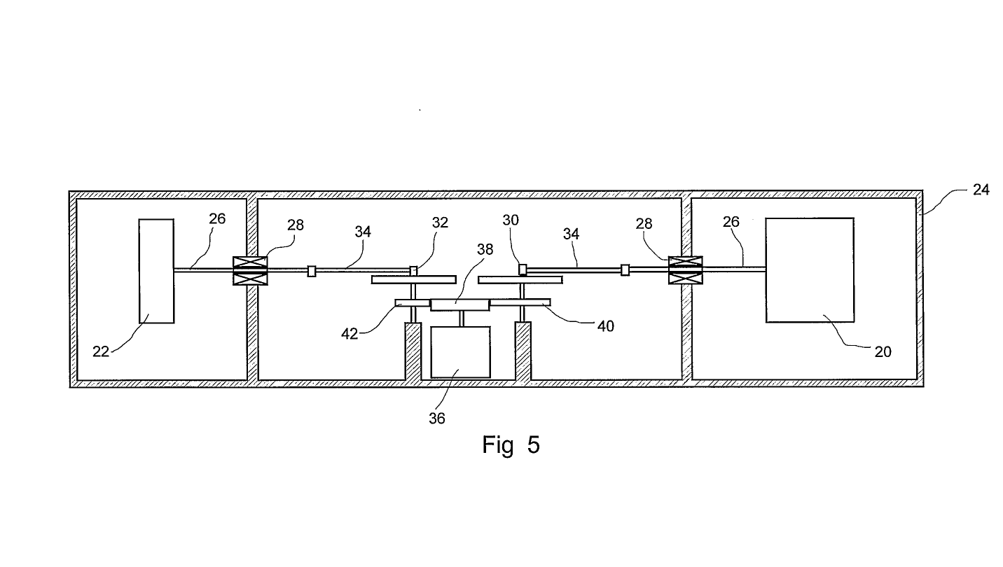

FIG. 5 illustrates a mechanical embodiment of the present invention, in which first and second masses 20, 22 are mounted coaxially in a tubular housing 24, the masses 20, 22 adjacent opposite ends of the housing 24. The masses 20, 22 are mounted on rods 26, which are slidingly located through linear bearings 28 in the housing 24. The ends of the rods 26 are connected to cranks 30, 32 by means of connecting rods 34.

The cranks 30, 32 are driven by an electric motor 36, through gears 38, 40 and 42. Gear 40 and 42 have a drive ratio of 1:2, so that crank 32 which is driven through gear 42 will rotate at twice the frequency as crank 30 which is driven by gear 40. Rotation of motor 36 will thus cause the masses 20, 22 to oscillate periodically, mass 22 moving at twice the frequency as mass 20. Mass 20 is four times that of mass 22 and the cranks 30, 32 have an equal throw, so that displacement of the masses 20, 22 is the same.

As described above rotation of the motor 36 will cause the masses 20, 22 to oscillate periodically, causing the housing 24 and any object or component to which it is mechanically coupled, to move. In order to reverse the direction of movement of the linear displacement device illustrated in FIG. 5, it is necessary to disengage the drive between the motor 36 and at least one of the cranks 30, 32 and alter the phase between the cranks by 90°.

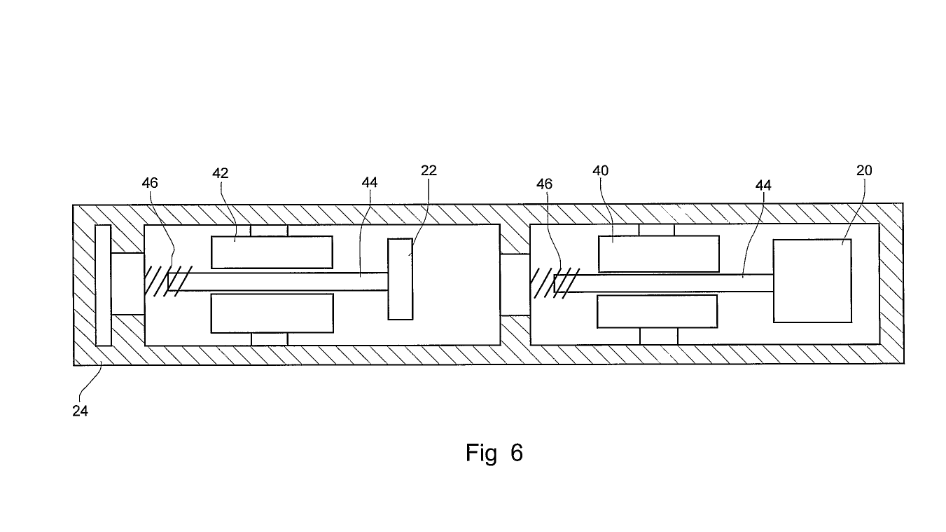

In the embodiment illustrated in FIG. 6, the electric motor 36 is replaced by a pair of solenoids 40, 42. The masses 20, 22 are each mounted at one end of a solenoid plunger 44, a return spring 46 acting on the opposite end of each plunger 44, so that on energisation of the solenoid 40, 42, the plunger 44 and mass 20, 22 attached thereto will be displaced to one side and on de-energisation of the solenoid 20, 22, the plunger 44 and mass 20, 22 attached thereto will be displaced to the other side by the return spring 46.

The solenoids 40, 42 are energised by separate, pulsed electric currents, the electric current energising solenoid 42 which drives mass 22 having twice the frequency of the current energising solenoid 40 which drives mass 20, so that the mass 22 moves at twice the angular frequency of mass 20. For movement in one direction, the two electric currents are maintained in phase. The direction of movement being reversed by varying the phase of one electric current by 90°.

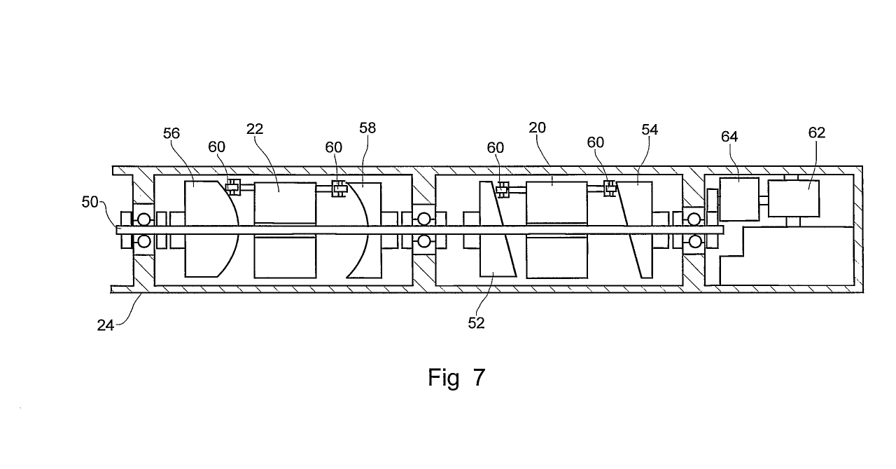

In the embodiment illustrated in FIG. 7, the masses 20, 22 are slidably mounted on a shaft 50, means being provided to prevent rotation of the masses 20, 22. Each of the masses 20, 22 are located between a pairs of cam formations 52, 54 and 56, 58, respectively. Each pair of cam formations 52, 54 and 56, 58 have correspondingly profiled radial cam surfaces, so that they define tracks with parallel walls, between which for the masses are located. Cam followers 60 attached to the masses 20, 22 engage the cam surfaces to locate to masses 20, 22 between the cam formations 52, 54 and 56, 58 respectively.

The cam formations 52, 54 define inclined planar cam surfaces such that as the shaft 50 rotates engagement of the cam followers with the cam formations, will cause the mass 20 to move axially of the shaft 50, the mass 20 moving backwards and forwards on the shaft 50, for each rotation of the shaft 50. Cam formations 56,58 define substantially C-shaped cam surfaces, so that for one rotation of the shaft 50 will move the mass 22 axially backward and forwards, twice. As the shaft 50 is rotated, the mass 22 will consequently oscillate at twice the angular frequency of mass 20.

With this embodiment, the direction of motion of the linear displacement device may be reversed by rotating one of the pairs of cam formations 52, 54 and 56, 58 by 90°, relative to the shaft 50 or by rotating the cam follower for one of the masses by 90°.

In modifications of the embodiment illustrated in FIG. 7, the masses 20, 22 may be slidingly mounted, for example on rails or rods, mounted parallel to the shaft 50 rather than on the shaft 50 itself. Moreover, movement of the masses 20, 22 may be controlled by single cam surfaces, the masses 20, 22 being resiliently biases towards the cam surfaces.

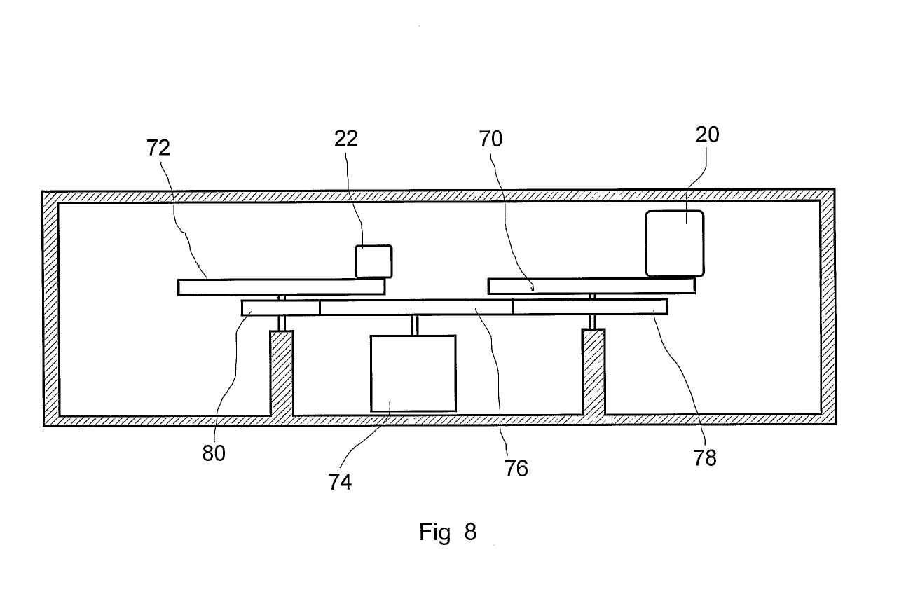

In the embodiment illustrated in FIG. 8, a pair of discs 70,72 are driven by an electric motor 74, via gears 76, 78, 80, so that disk 72 is driven at twice the frequency as disk 70. Masses 20 and 22 are mounted on the discs 70 and 72 respectively, at distances spaced equally from their axes of rotation. Even though in this embodiment, the masses 20, 22 are rotating, provided that the device is constrained to move in a plain perpendicular to the axes of rotation of the masses 20, 22, the device will move in that plain.

Linear displacement devices in accordance with the present invention, may be used to move an object or component, in similar applications to other known actuators, for example mechanical actuators (ball and screw, worm gear etc.), telescopic drives, magnetic linear actuators, piezo electric motors, linear induction motors, provided that a minimum force is required to move the object or component, in both one direction and the opposite direction.

Linear displacement devices in accordance with the present invention have the advantage that they are self contained and may be totally encapsulated, making them suitable for use in applications in harsh environments. Furthermore the linear displacement devices of the present invention need only minimal mechanical coupling to the object or component, in contrast to, for example screw actuators or worm gears.

The following examples are intended to be exemplary of possible applications of the linear displacement devices of the present invention and are not intended to be exhaustive.

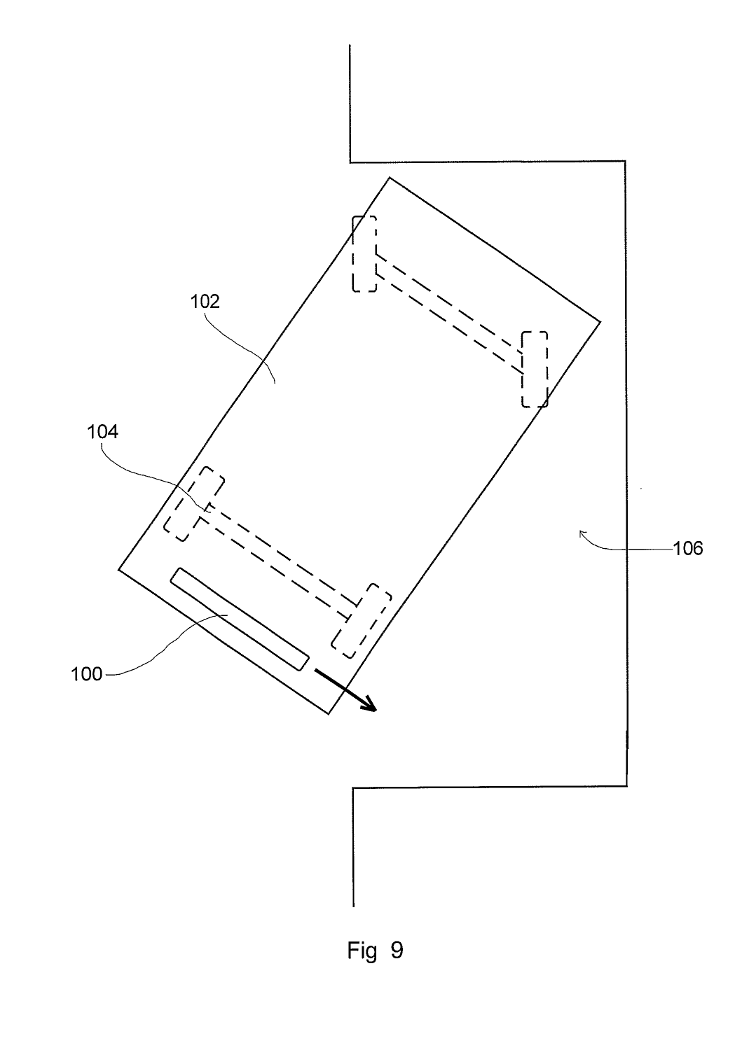

As illustrated in FIG. 9, a linear displacement device 100, of the type disclosed with reference to FIG. 5 is mounted transversely of a motor vehicle 102 adjacent the rear axle 104. Actuation of the linear displacement device 100 may thus be used to swing the rear end of the vehicle 102 round, in order to assist in the parking of the vehicle 102 in a restricted space 106. The linear displacement device 100 provides means of propulsion of the vehicle 102, from within its own boundary, with no expulsion of material, or external moving parts, beyond its own boundary.

The linear displacement device 100 may be powered externally from the vehicle's electrical system or may have a dedicated power source. The linear displacement device 100, requires only rigid mechanical or frictional coupling to the vehicle 102, by for example bolting or other suitable fastening means, allowing easy installation or removal from the vehicle 102.

In an alternative arrangement, a pair of linear displacement devices 100 may be used, one adjacent the front axle and the other adjacent the rear axle of the vehicle 102, in order to permit parallel parking of the vehicle 102.

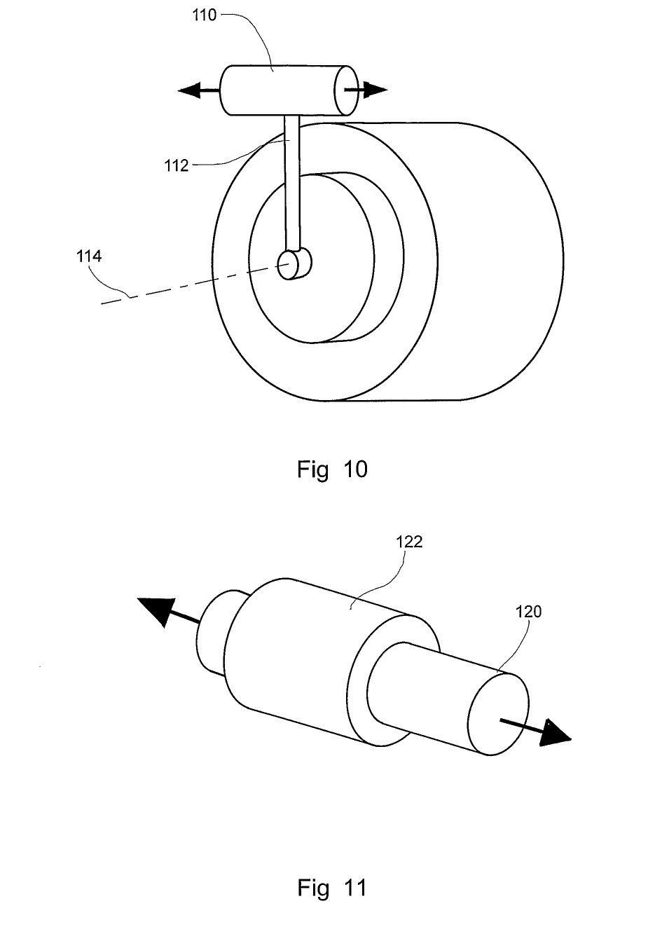

As illustrated in FIG. 10, a linear displacement device 110 according to the present invention is mounted on an arm 112, which is mounted, at one end for movement about an axis 114. The linear displacement device is mounted to the arm 112 at a position spaced from the axis 114, the direction of motion of the linear displacement device 110, being transverse to the arm 112 and in the plane of rotation of the arm 112 about the axis 114.

The linear displacement device 110 when actuated will consequently apply a torque force to the arm 112, causing it to rotate about the axis 114, thereby providing a rotary actuator. The arm 112 of the device disclosed above, may be for example the control lever of a rotary valve, the linear displacement device controlling opening and closing of the valve. Alternatively, the arm 112 may be the arm of a robot, which is attached to the robot by a rotary joint, the linear displacement device controlling movement of the device. With actuators of this type, where movement in both directions is required, it is expedient to utilise linear displacement devices which may easily be reversed, for example by altering the relative phase of the energising currents controlling oscillation of the masses, as described in the embodiment illustrated in FIG. 6.

FIG. 11 shows a linear actuator, in which a linear displacement device 120, of the type described with reference to any one of FIGS. 5 to 8, is telescopically mounted in frictional engagement with an outer tubular housing 122. Oscillation of the masses in the linear displacement device 120, will thus cause the linear displacement device 120 to move with respect to the outer housing, extending or contracting the actuator.

Various modifications may be made without departing from the invention.

For example, in the above embodiments, the frequencies of oscillation of the masses are whole number multiples of the lowest frequency of oscillation, so that the masses remain in phase, for movement in one direction, a phase shift being required to reverse the direction of movement. In alternative embodiments of the invention, the frequencies of oscillation of the masses may be such that over a period, the phase relationship between the masses will shift, so that the linear displacement device will move in one direction for a predetermined time period and will then reverse and return to its original position.

While with a two mass linear displacement device, the phase must be altered by 90° in order to reverse the direction of movement, with linear displacement devices with more than two masses the phase shift required to reverse the direction of movement will differ.

1.-17. (canceled)

18. A linear displacement device comprising:
a body;
a plurality of masses mechanically coupled to the body for reciprocating movement in a common direction with respect to the body;
means for driving the masses so that the masses oscillate periodically with different frequencies of oscillation such that:
over a time period T₀ to T₁, a resultant impulse produced by the periodic oscillation of the masses is:
$${\int }_{T 0}^{T 1} Fx ( t ) \cdot d t = 0$$
where:—
Fx(t) is the resultant force produced by oscillation of the masses at a particular instant in time=[Fx1(t)+Fx2(t)+ . . . +Fxn(t)]; and Fx1(t), Fx2(t) . . . Fxn(t) is the force applied to the body at a particular instant in time by a first oscillating mass, a second oscillating mass . . . and by an n^{th} oscillating mass respectively;
and,
over that time period T₀ to T₁,
$${\int }_{T 0}^{T 1} Sx ( t ) \cdot d t \neq 0$$

19. The linear displacement device according to claim 18, wherein movement of the body is opposed by friction, a viscous drag of a fluid, a mechanical torque or an electric or magnetic field.

20. The linear displacement device according to claim 18, wherein the frequency of oscillation of the masses are multiples of a lowest frequency.

21. The linear displacement device according to claim 18, wherein the masses oscillate in phase.

22. The linear displacement device according to claim 21, wherein a means is provided for introducing a phase shift between the alternating masses in order to change direction of motion of the body.

23. The linear displacement device according to claim 18, wherein the masses oscillate out of phase such that over a period, the phase relationship between the masses will vary and the direction of movement of the body reversing over that period.

24. The linear displacement device according to claim 18, wherein at least one of the mass and displacement of each of the masses is varied with its frequency of oscillation such that the maximum force produced by each of the masses is equal.

25. The linear displacement device according to claim 18, wherein first and second masses are mechanically coupled to the body, and the second mass oscillates at a frequency twice the frequency of the first mass.

26. The linear displacement device according to claim 25, wherein the first mass is four times the mass of the second mass.

27. The linear displacement device according to claim 18, wherein the masses are mounted to the body for reciprocating motion in a common direction, the masses are driven by motors connected to the masses by cranks.

28. The linear displacement device according to claim 18, wherein the masses are driven angularly in a common horizontal plane, and the masses are offset from the axis of rotation.

29. The linear displacement device according to claim 27, wherein the masses are driven by a common motor with gearing provided for driving the masses at different frequencies.

30. The linear displacement device according to claim 18, wherein the masses are mounted for reciprocating motion on a common shaft, the masses engaging cam surfaces mounted on the shaft for rotation therewith, so that upon rotation of the shaft, the cam surfaces cause to masses to reciprocate axially of the shaft, the cam surfaces being configured to reciprocate the masses at different frequencies.

31. The linear displacement device according to claim 18, wherein the means for driving the masses so that the masses oscillate periodically with different and variable frequencies of oscillation, comprises an electromagnetic coupling of each mass to a separate electromagnetic coil, and each electromagnetic coil is energised separately at a variable frequency.

32. The rotary device comprising a linear displacement device as claimed in claim 18, the linear displacement device is mounted on a component, the component is mounted for rotation about an axis, the linear displacement device is mounted on the component at a position spaced from the axis, and the direction of reciprocation of the masses of the linear actuator is transverse to the line joining the linear displacement device to the axis of rotation of the component.
